(19) United States
(12) Patent Application Publication
(10) Pub. No.: US 2026/0211115 A1
(43) Pub. Date: Jul. 23, 2026

(54) VEHICLE SYSTEMS AND RELATED CRACK VALIDATION METHODS

(71) Applicant: GM GLOBAL TECHNOLOGY OPERATIONS LLC, Detroit, MI (US)

(72) Inventors: Siva Chinthalapudi, Novi, MI (US); Nadia Abousaleh, Dearborn, MI (US); James Foresi, Bloomfield Hills, MI (US)

(73) Assignee: GM GLOBAL TECHNOLOGY OPERATIONS LLC, Detroit, MI (US)

(21) Appl. No.: 19/033,947

(22) Filed: Jan. 22, 2025

(51) Int. Cl. G01S 17/88; B60W 50/00; G01S 7/48

(52) U.S. Cl. CPC G01S 17/88; B60W 50/0098; G01S 7/4802

(57) ABSTRACT

Vehicles and methods are provided for detection of cracks or other anomalies associated with a transparent structure within the field of view of an onboard sensor. One method involves identifying when a difference between a first average of a first set of measurement data and a second average of a second set of measurement data associated with a field of view of a lidar is greater than a zone analysis threshold, and thereafter identifying an anomaly for a discrete zone within the field of view when a second difference between respective subsets of the first set of measurement data and the second set of measurement data corresponding to a distinct subset of the field of view is greater than a detection threshold. The method validates detection of the anomaly based on the distinct subset of the second set of measurement data and automatically initiates remedial action in response to validation.

### INTRODUCTION

The technical field generally relates to vehicle systems and more particularly relates to detecting cracks or other anomalies with respect to a transparent surface associated with a sensor supporting autonomous driver assistance of a vehicle.

Modern vehicles include various enhanced or advanced features to support a human driver operating a vehicle. Many vehicles are capable of sensing their environment and facilitating vehicle operation. For example, an autonomous vehicle or other vehicle capable of supporting autonomous operating modes senses its environment using sensing devices such as radar, lidar, image sensors, and the like. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Automated driver assistance technologies hold the potential to improve user experience. However, the sheer number of different variables in a real-world environment pose challenges to maintaining availability of autonomous driver assistance features without disrupting the user experience. Accordingly, it is desirable to provide systems and methods for validating detection of anomalies associated with onboard sensors to maintain driver assistance functionality for improved performance over a longer period of time.

### SUMMARY

Apparatus for a vehicle and related methods and vehicle systems are provided. One method of operating a vehicle involves obtaining, by a controller associated with the vehicle from a lidar associated with the vehicle, a first set of measurement data associated with a field of view of the lidar, obtaining, by the controller, a second set of measurement data associated with the field of view of the lidar at a subsequent point in time, identifying, by the controller, when a difference between a first average of the first set of measurement data and a second average of the second set of measurement data is greater than a zone analysis threshold, and when the difference is greater than the zone analysis threshold, identifying, by the controller, an anomalous condition associated with a distinct subset of the field of view when a second difference between respective subsets of the first set of measurement data and the second set of measurement data corresponding to the distinct subset of the field of view is greater than an anomaly detection threshold, validating, by the controller, the anomalous condition associated with the distinct subset of the field of view based on the respective subset of the second set of measurement data corresponding to the distinct subset of the field of view, and automatically initiating, by the controller, one or more remedial actions in response to validating the anomalous condition associated with the distinct subset of the field of view.

In one implementation, the first set of measurement data is a first frame of lidar measurement data at a first sampling time, the second set of measurement data is a second frame of lidar measurement data at a second sampling time subsequent to the first sampling time, identifying the difference is greater than the zone analysis threshold involves identifying the difference between a first average value for the first frame of lidar measurement data and a second average value for the second frame of lidar measurement data is greater than the zone analysis threshold, and identifying the anomalous condition involves identifying a crack associated with a distinct zone within the field of view when the second difference between a third average value for a first subset of the first frame of lidar measurement data corresponding to the distinct zone and fourth average value for a second subset of the second frame of lidar measurement data corresponding to the distinct zone is greater than a crack detection threshold.

In one implementation, validating the anomalous condition involves validating detection of the crack when a third difference between the fourth average value for the second subset of the second frame of lidar measurement data and a fifth average value for a third subset of a third frame of lidar measurement data at a third sampling time corresponding to the distinct zone is less than a crack validation threshold and the third sampling time is subsequent to the second sampling time.

In another implementation, the crack is disposed within a transparent structure in a line-of-sight of the lidar aligned with the distinct zone within the field of view.

In one implementation, the method involves obtaining, by the controller, a third set of measurement data associated with the field of view of the lidar at a third point in time after identifying the anomalous condition, wherein validating the anomalous condition involves validating persistence of the anomalous condition when a third difference between respective subsets of the second set of measurement data and the third set of measurement data corresponding to the distinct subset of the field of view is less than a validation threshold.

In another implementation, validating the anomalous condition involves validating detection of a crack in a transparent structure in a line-of-sight of the lidar aligned with the distinct subset of the field of view when an estimated distance associated with first returns associated with the respective subset of the second set of measurement data corresponding to the distinct subset of the field of view is less than a crack validation threshold. In one implementation, the crack validation threshold is less than or equal to a distance between a light source of the lidar and the transparent structure.

In another implementation, the first set of measurement data includes a first frame of lidar measurement data from the lidar at a first sampling time, the second set of measurement data includes a second frame of lidar measurement data from the lidar at a second sampling time subsequent to the first sampling time, identifying the difference is greater than the zone analysis threshold involves identifying the difference between a first average measurement value for the first frame of lidar measurement data and a second average measurement value for the second frame of lidar measurement data is greater than the zone analysis threshold, and identifying the anomalous condition involves identifying a crack associated with a transparent structure in a line-of-sight of the lidar within a distinct zone within the field of view when the second difference between a third average measurement value for a first subset of the first frame of lidar measurement data corresponding to the distinct zone and fourth average measurement value for a second subset of the second frame of lidar measurement data corresponding to the distinct zone is greater than a crack detection threshold.

In one implementation, validating the anomalous condition involves validating detection of the crack when a third difference between the fourth average measurement value for the second subset of the second frame of lidar measurement data and a fifth average measurement value for a third subset of a third frame of lidar measurement data from the lidar at a third sampling time corresponding to the distinct zone is less than a crack validation threshold and the third sampling time is subsequent to the second sampling time.

In an exemplary implementation, an apparatus is provided for a non-transitory computer-readable medium including executable instructions that, when executed by a processor, cause the processor to provide a crack detection service configurable to obtain, from a lidar associated with a vehicle, a first set of sensor data associated with a field of view of the lidar, obtain, from the lidar, a second set of sensor data associated with the field of view of the lidar at a subsequent point in time, identify when a difference between a first average of the first set of sensor data and a second average of the second set of sensor data is greater than a zone analysis threshold, and when the difference is greater than the zone analysis threshold, identify a crack associated with a distinct subset of the field of view when a second difference between respective subsets of the first set of sensor data and the second set of sensor data corresponding to the distinct subset of the field of view is greater than a crack detection threshold, validate detection of the crack associated with the distinct subset of the field of view based on the respective subset of the second set of sensor data corresponding to the distinct subset of the field of view, and automatically initiate one or more remedial actions in response to validating detection of the crack associated with the distinct subset of the field of view.

In one implementation, the first set of sensor data includes a first frame of sensor measurement data at a first sampling time, the second set of sensor data includes a second frame of sensor measurement data at a second sampling time subsequent to the first sampling time, and the crack detection service is configurable to identify the difference between a first average value for the first frame of sensor measurement data and a second average value for the second frame of sensor measurement data is greater than the zone analysis threshold and identify the crack associated with a distinct zone within the field of view when the second difference between a third average value for a first subset of the first frame of sensor measurement data corresponding to the distinct zone and fourth average value for a second subset of the second frame of sensor measurement data corresponding to the distinct zone is greater than the crack detection threshold.

In one implementation, the crack detection service is configurable to validate the detection of the crack when a third difference between the fourth average value for the second subset of the second frame of sensor measurement data and a fifth average value for a third subset of a third frame of sensor measurement data at a third sampling time corresponding to the distinct zone is less than a crack validation threshold, wherein the third sampling time is subsequent to the second sampling time.

In another implementation, the crack is disposed within a transparent structure in a line-of-sight of the lidar aligned with a distinct zone within the field of view.

In another implementation, the crack detection service is configurable to obtain a third set of sensor data associated with the field of view of the lidar at a third point in time after identifying the crack and validate the detection of the crack when a third difference between respective subsets of the second set of sensor data and the third set of sensor data corresponding to the distinct subset of the field of view is less than a crack validation threshold.

In another implementation, the crack detection service is configurable to validate the detection of the crack in a transparent structure in a line-of-sight of the lidar aligned with the distinct subset of the field of view when an estimated distance of first returns associated with the respective subset of the second set of sensor data corresponding to the distinct subset of the field of view is less than a crack validation threshold.

In another implementation, the crack validation threshold is less than or equal to a distance between a light source of the lidar and the transparent structure.

In another implementation, the first set of sensor data includes a first frame of lidar sensor measurement data from the lidar at a first sampling time, the second set of sensor data includes a second frame of lidar sensor measurement data from the lidar at a second sampling time subsequent to the first sampling time, and the crack detection service is configurable to identify the difference between a first average measurement value for the first frame of lidar sensor measurement data and a second average measurement value for the second frame of lidar sensor measurement data is greater than the zone analysis threshold and identify the crack associated with a transparent structure in a line-of-sight of the lidar within a distinct zone within the field of view when the second difference between a third average measurement value for a first subset of the first frame of lidar sensor measurement data corresponding to the distinct zone and fourth average measurement value for a second subset of the second frame of lidar sensor measurement data corresponding to the distinct zone is greater than the crack detection threshold.

In another implementation, the crack detection service is configurable to validate the detection of the crack when a third difference between the fourth average measurement value for the second subset of the second frame of lidar sensor measurement data and a fifth average measurement value for a third subset of a third frame of lidar sensor measurement data from the lidar at a third sampling time corresponding to the distinct zone is less than a crack validation threshold, wherein the third sampling time is subsequent to the second sampling time.

An apparatus for a vehicle is also provided. The vehicle includes a lidar sensing device, a transparent structure disposed within a field of view of the lidar sensing device, and a control module coupled to the lidar sensing device, wherein the control module is configurable to obtain, from the lidar sensing device, a first set of sensor data associated with the field of view of the lidar sensing device, obtain, from the lidar sensing device, a second set of sensor data associated with the field of view of the lidar sensing device at a subsequent point in time, identify when a difference between a first average of the first set of sensor data and a second average of the second set of sensor data is greater than a zone analysis threshold, and when the difference is greater than the zone analysis threshold, identify a crack associated with the transparent structure within a distinct subset of the field of view when a second difference between respective subsets of the first set of sensor data and the second set of sensor data corresponding to the distinct subset of the field of view is greater than a crack detection threshold, validate detection of the crack associated with the distinct subset of the field of view based on the respective subset of the second set of sensor data corresponding to the distinct subset of the field of view, and automatically initiate one or more remedial actions in response to validating detection of the crack associated with the distinct subset of the field of view.

In one implementation, the first set of sensor data includes a first frame of lidar sensor measurement data from the lidar sensing device at a first sampling time, the second set of sensor data includes a second frame of lidar sensor measurement data from the lidar sensing device at a second sampling time subsequent to the first sampling time, and the control module is configurable to identify the difference between a first average measurement value for the first frame of lidar sensor measurement data and a second average measurement value for the second frame of lidar sensor measurement data is greater than the zone analysis threshold and identify the crack associated with the transparent structure within a distinct zone within the field of view when the second difference between a third average measurement value for a first subset of the first frame of lidar sensor measurement data corresponding to the distinct zone and fourth average measurement value for a second subset of the second frame of lidar sensor measurement data corresponding to the distinct zone is greater than the crack detection threshold.

### BRIEF DESCRIPTION OF THE DRAWINGS

The exemplary aspects will hereinafter be described in conjunction with the following drawing figures, wherein like numerals denote like elements, and wherein:

FIG. 1 is a block diagram illustrating a vehicle system in accordance with various implementations;

FIG. 2 is a block diagram illustrating an autonomous driving system (ADS) suitable for use with the vehicle system of FIG. 1 in accordance with various implementations;

FIG. 3 is a block diagram illustrating perception system suitable for use with the vehicle system of FIG. 1 in accordance with various implementations;

FIG. 4 is a flow diagram illustrating a crack detection process suitable for implementation by a controller of a vehicle system according to one or more implementations described herein; and

FIG. 5 depicts an exemplary relationship between successive sets of sensor measurement data suitable for use with the crack detection process of FIG. 4 in accordance with one or more exemplary implementations.

### DETAILED DESCRIPTION

The following detailed description is merely exemplary in nature and is not intended to limit the application and uses. Furthermore, there is no intention to be bound by any expressed or implied theory presented in the preceding introduction, summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

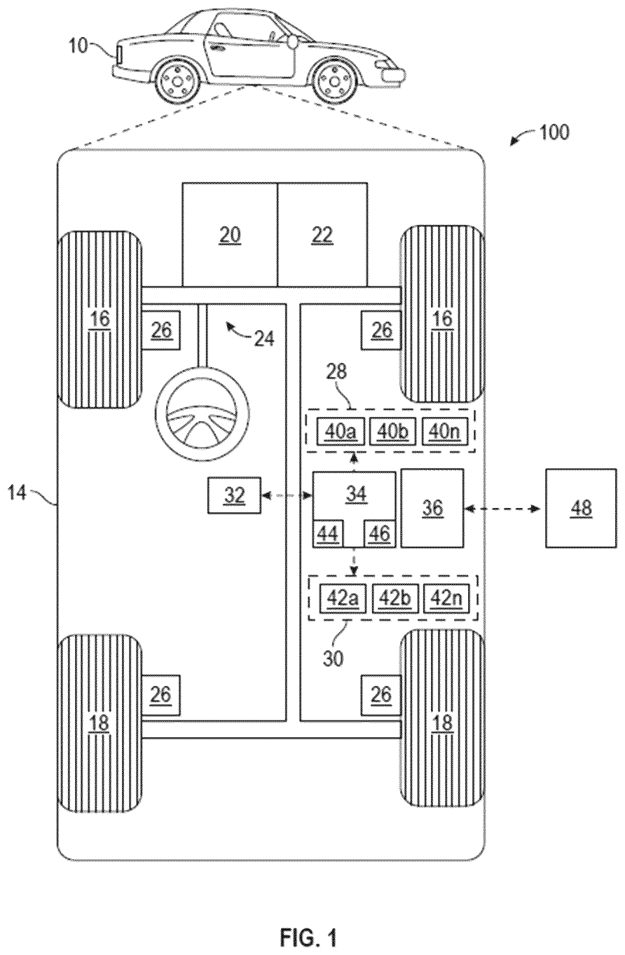

FIG. 1 depicts an exemplary implementation of a vehicle system 100 suitable for providing one or more driver assistance features or functionality that supports autonomous operation of a vehicle 10. In this regard, in some implementations, the vehicle system 100 is capable of determining a plan for autonomously operating a vehicle 10 along a route in a manner that accounts for objects or obstacles detected by sensors 40 of an onboard sensor system 28. As depicted in FIG. 1, the vehicle 10 generally includes a chassis, a body 14, and front and rear wheels 16, 18 rotationally coupled to the chassis near a respective corner of the body 14. The body 14 is arranged on the chassis and substantially encloses components of the vehicle 10, and the body 14 and the chassis may jointly form a frame.

In exemplary implementations, the vehicle 10 is an autonomous vehicle or is otherwise configured to support one or more autonomous operating modes, and the vehicle system 100 is incorporated into the vehicle 10 (hereinafter referred to as the vehicle 10). The vehicle 10 is depicted in the illustrated implementation as a passenger car, but it should be appreciated that any other vehicle including motorcycles, trucks, sport utility vehicles (SUVs), recreational vehicles (RVs), marine vessels, aircraft, etc., can also be used. In an exemplary implementation, the vehicle 10 is a so-called Level Two automation system. A Level Two system indicates “partial driving automation,” referring to the driving mode-specific performance by an automated driving system to control steering, acceleration and braking in specific scenarios while a driver remains alert and actively supervises the automated driving system at all times and is capable of providing driver support to control primary driving tasks. For example, the vehicle system 100 may support an adaptive cruise control (ACC) autonomous operating mode or other driver assistance functionality that autonomously controls steering to facilitate maintaining the vehicle 10 in a desired lane of travel with a desired speed.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various implementations, include an internal combustion engine, an electric machine such as a traction motor, and/or a fuel cell propulsion system. The transmission system 22 is configured to transmit power from the propulsion system 20 to the vehicle wheels 16, 18 according to selectable speed ratios. According to various implementations, the transmission system 22 may include a step-ratio automatic transmission, a continuously-variable transmission, or other appropriate transmission. The brake system 26 is configured to provide braking torque to the vehicle wheels 16, 18. The brake system 26 may, in various implementations, include friction brakes, brake by wire, a regenerative braking system such as an electric machine, and/or other appropriate braking systems. The steering system 24 influences a position of the of the vehicle wheels 16, 18. While depicted as including a steering wheel for illustrative purposes, in some implementations contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various implementations, the vehicle features can further include interior and/or exterior vehicle features such as, but are not limited to, doors, a trunk, and cabin features such as air, music, lighting, etc. (not numbered).

The data storage device 32 stores data for use in automatically controlling the vehicle 10, such as, for example, calibration data. In various implementations, the data storage device 32 stores defined maps of the navigable environment. In various implementations, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, implementations of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various implementations, one or more instructions of the controller 34 are embodied in the vehicle system 100 (e.g., in data storage element 46) and, when executed by the processor 44, cause the processor 44 to obtain data captured or generated from imaging and ranging devices 40 and utilize the captured environmental data to determine commands for autonomously operating the vehicle 10, as described in greater detail below. In one or more exemplary implementations, the data storage element 46 maintains information that may be utilized to determine corresponding a lateral reference trajectory for maneuvering laterally, with the resulting reference lateral trajectory being utilized or otherwise referenced by the processor 44 to determine steering commands for autonomously operating the vehicle 10 to mitigate lateral deviations from the desired lane of travel.

Still referring to FIG. 1, in exemplary implementations, the communication system 36 is configured to wirelessly communicate information to and from other entities 48 over a communication network, such as but not limited to, other vehicles (“V2V” communication,) infrastructure (“V2I” communication), remote systems, and/or personal devices. In an exemplary implementation, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The communication network utilized by the communication system 36 can include a wireless carrier system such as a cellular telephone system that includes a plurality of cell towers (not shown), one or more mobile switching centers (MSCs) (not shown), as well as any other networking components required to connect the wireless carrier system with a land communications system, and the wireless carrier system can implement any suitable communications technology, including for example, digital technologies such as CDMA (e.g., CDMA 2000), LTE (e.g., 4G LTE or 5G LTE), GSM/GPRS, or other current or emerging wireless technologies. Additionally, or alternatively, a second wireless carrier system in the form of a satellite communication system can be utilized to provide uni-directional or bi-directional communication using one or more communication satellites (not shown) and an uplink transmitting station (not shown), including, but not limited to satellite radio services, satellite telephony services and/or the like. Some implementations may utilize a land communication system, such as a conventional land-based telecommunications network including a public switched telephone network (PSTN) used to provide hardwired telephony, packet-switched data communications, and the Internet infrastructure. One or more segments of a land communication system can be implemented using a standard wired network, a fiber or other optical network, a cable network, power lines, other wireless networks such as wireless local area networks (WLANs), or networks providing broadband wireless access (BWA), or any combination thereof.

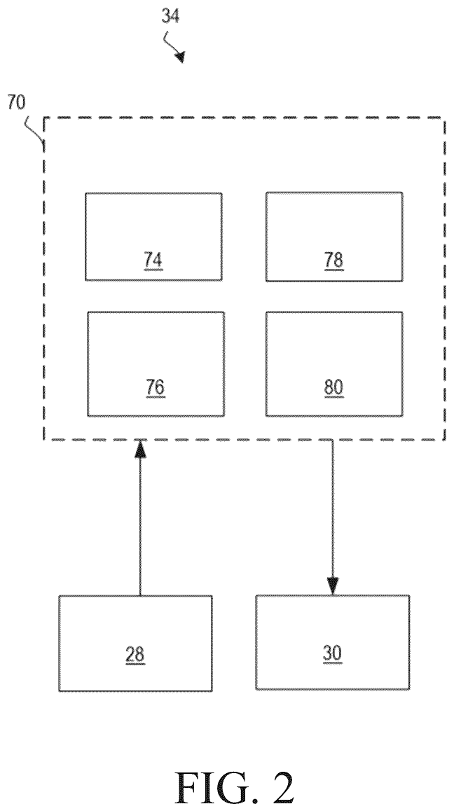

Referring now to FIG. 2, in accordance with various implementations, controller 34 implements an autonomous driving system (ADS) 70. That is, suitable software and/or hardware components of controller 34 (e.g., processor 44 and computer-readable storage device 46) are utilized to provide an autonomous driving system 70 that is used in conjunction with vehicle 10, for example, to automatically control various actuators 30 and thereby control vehicle acceleration, steering, and braking, respectively, without human intervention.

In various implementations, the instructions of the autonomous driving system 70 may be organized by function or system. For example, as shown in FIG. 2, the autonomous driving system 70 can include a sensor fusion system 74, a positioning system 76, a guidance system 78, and a vehicle control system 80. As can be appreciated, in various implementations, the instructions may be organized into any number of systems (e.g., combined, further partitioned, etc.) as the disclosure is not limited to the present examples.

In various implementations, the sensor fusion system 74 synthesizes and processes sensor data and predicts the presence, location, classification, and/or path of objects and features of the environment of the vehicle 10. In various implementations, the sensor fusion system 74 can incorporate information from multiple sensors, including but not limited to cameras, lidars, radars, and/or any number of other types of sensors. In one or more exemplary implementations described herein, the sensor fusion system 74 correlates image data to lidar point cloud data, the vehicle reference frame, or some other reference coordinate frame using calibrated conversion parameter values associated with the pairing of the respective camera and reference frame to relate lidar points to pixel locations, assign depths to the image data, identify objects in one or more of the image data and the lidar data, or otherwise synthesize associated image data and lidar data. In other words, the sensor output from the sensor fusion system 74 provided to the vehicle control system 80 (e.g., indicia of detected objects and/or their locations relative to the vehicle 10) reflects or is otherwise influenced by the calibrations and associations between camera images, lidar point cloud data, and the like.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow given the current sensor data and current vehicle pose. The vehicle control system 80 then generates control signals for controlling the vehicle 10 according to the determined path. In various implementations, the controller 34 implements machine learning techniques to assist the functionality of the controller 34, such as feature detection/classification, obstruction mitigation, route traversal, mapping, sensor integration, ground-truth determination, and the like.

In one or more implementations, the guidance system 78 includes a motion planning module that generates a motion plan for controlling the vehicle as it traverses along a route. The motion planning module includes a longitudinal solver module that generates a longitudinal motion plan output for controlling the movement of the vehicle along the route in the general direction of travel, for example, by causing the vehicle to accelerate or decelerate at one or more locations in the future along the route to maintain a desired speed or velocity. The motion planning module also includes a lateral solver module that generates a lateral motion plan output for controlling the lateral movement of the vehicle along the route to alter the general direction of travel, for example, by steering the vehicle at one or more locations in the future along the route (e.g., to maintain the vehicle centered within a lane, change lanes, etc.). The longitudinal and lateral plan outputs correspond to the commanded (or planned) path output provided to the vehicle control system 80 for controlling the vehicle actuators 30 to achieve movement of the vehicle 10 along the route that corresponds to the longitudinal and lateral plans.

During normal operation, the longitudinal solver module attempts to optimize the vehicle speed (or velocity) in the direction of travel, the vehicle acceleration in the direction of travel, and the derivative of the vehicle acceleration in the direction of travel, alternatively referred to herein as the longitudinal jerk of the vehicle, and the lateral solver module attempts to optimize one or more of the steering angle, the rate of change of the steering angle, and the acceleration or second derivative of the steering angle, alternatively referred to herein as the lateral jerk of the vehicle. In this regard, the steering angle can be related to the curvature of the path or route, and any one of the steering angle, the rate of change of the steering angle, and the acceleration or second derivative of the steering angle can be optimized by the lateral solver module, either individually or in combination.

In an exemplary implementation, the longitudinal solver module receives or otherwise obtains the current or instantaneous pose of the vehicle, which includes the current position or location of the vehicle, the current orientation of the vehicle, the current speed or velocity of the vehicle, and the current acceleration of the vehicle. Using the current position or location of the vehicle, the longitudinal solver module also retrieves or otherwise obtains route information which includes information about the route the vehicle is traveling along given the current pose and plus some additional buffer distance or time period (e.g., 12 seconds into the future), such as, for example, the current and future road grade or pitch, the current and future road curvature, current and future lane information (e.g., lane types, boundaries, and other constraints or restrictions), as well as other constraints or restrictions associated with the roadway (e.g., minimum and maximum speed limits, height or weight restrictions, and the like). The route information may be obtained from, for example, an onboard data storage element 32, an online database, or other entity. In one or more implementations, the lateral route information may include the planned lateral path command output by the lateral solver module, where the longitudinal and lateral solver modules iteratively derive an optimal travel plan along the route.

The longitudinal solver module also receives or otherwise obtains the current obstacle data relevant to the route and current pose of the vehicle, which may include, for example, the location or position, size, orientation or heading, speed, acceleration, and other characteristics of objects or obstacles in a vicinity of the vehicle or the future route. The longitudinal solver module also receives or otherwise obtains longitudinal vehicle constraint data which characterizes or otherwise defines the kinematic or physical capabilities of the vehicle for longitudinal movement, such as, for example, the maximum acceleration and the maximum longitudinal jerk, the maximum deceleration, and the like. The longitudinal vehicle constraint data may be specific to each particular vehicle and may be obtained from an onboard data storage element 32 or from a networked database or other entity 48, 52, 54. In some implementations, the longitudinal vehicle constraint data may be calculated or otherwise determined dynamically or substantially in real-time based on the current mass of the vehicle, the current amount of fuel onboard the vehicle, historical or recent performance of the vehicle, and/or potentially other factors. In one or more implementations, the longitudinal vehicle constraint data is calculated or determined in relation to the lateral path, the lateral vehicle constraint data, and/or determinations made by the lateral solver module. For example, the maximum longitudinal speed may be constrained at a particular location by the path curvature and the maximum lateral acceleration by calculating the maximum longitudinal speed as a function of the path curvature and the maximum lateral acceleration (which itself could be constrained by rider preferences or vehicle dynamics). In this regard, at locations where the degree of path curvature is relatively high (e.g., sharp turns), the maximum longitudinal speed may be limited accordingly to maintain comfortable or achievable lateral acceleration along the curve.

Using the various inputs to the longitudinal solver module, the longitudinal solver module calculates or otherwise determines a longitudinal plan (e.g., planned speed, acceleration and jerk values in the future as a function of time) for traveling along the route within some prediction horizon (e.g., 12 seconds) by optimizing some longitudinal cost variable or combination thereof (e.g., minimizing travel time, minimizing fuel consumption, minimizing jerk, or the like) by varying the speed or velocity of the vehicle from the current pose in a manner that ensures the vehicle complies with longitudinal ride preference information to the extent possible while also complying with lane boundaries or other route constraints and avoiding objects or obstacles. In this regard, in many conditions, the resulting longitudinal plan generated by the longitudinal solver module does not violate the maximum vehicle speed, the maximum vehicle acceleration, the maximum deceleration, and the maximum longitudinal jerk settings associated with the user, while also adhering to the following distances or buffers associated with the user. That said, in some scenarios, violating one or more longitudinal ride preference settings may be necessary to avoid obstacles, comply with traffic signals, or the like, in which case, the longitudinal solver module may attempt to maintain compliance of as many of the user-specific longitudinal ride preference settings as possible. Thus, the resulting longitudinal plan generally complies with the user's longitudinal ride preference information but does not necessarily do so strictly.

In a similar manner, the lateral solver module receives or otherwise obtains the current vehicle pose and the relevant route information and obstacle data for determining a lateral travel plan solution within the prediction horizon. The lateral solver module also receives or otherwise obtains lateral vehicle constraint data which characterizes or otherwise defines the kinematic or physical capabilities of the vehicle for lateral movement, such as, for example, the maximum steering angle or range of steering angles, the minimum turning radius, the maximum rate of change for the steering angle, and the like. The lateral vehicle constraint data may also be specific to each particular vehicle and may be obtained from an onboard data storage element 32 or from a networked database or other entity 48, 52, 54. The lateral solver module may also receive or otherwise obtain user-specific lateral ride preference information which includes, for example, user-specific values or settings for the steering rate (e.g., a maximum rate of change for the steering angle, a maximum acceleration of the steering angle, and/or the like), the lateral jerk, and the like. The lateral ride preference information may also include user-specific distances or buffers, such as, for example, a minimum and/or maximum distance from lane boundaries, a minimum lateral buffer or lateral separation distance between objects or obstacles, and the like, and potentially other user-specific lane preferences (e.g., a preferred lane of travel).

Using the various inputs to the lateral solver module, the lateral solver module calculates or otherwise determines a lateral plan for traveling along the route at future locations within some prediction horizon (e.g., 50 meters) by optimizing some lateral cost variable or combination thereof (e.g., minimizing deviation from the center of the roadway, minimizing the curvature of the path, minimizing lateral jerk, or the like) by varying the steering angle or vehicle wheel angle in a manner that ensures the vehicle complies with the lateral ride preference information to the extent possible while also complying with lane boundaries or other route constraints and avoiding objects or obstacles.

During normal operation, the lateral solver module may utilize the longitudinal travel plan from the longitudinal solver module along with the route information and obstacle data to determine how to steer the vehicle from the current pose within the prediction horizon while attempting to comply with the lateral ride preference information. In this regard, the resulting longitudinal and lateral travel plans that are ultimately output by the motion planning module comply with as many of the user's ride preferences as possible while optimizing the cost variable and avoiding obstacles by varying one or more of the vehicle's velocity, acceleration/deceleration (longitudinally and/or laterally), jerk (longitudinally and/or laterally), steering angle, and steering angle rate of change. The longitudinal travel plan output by the motion planning module includes a sequence of planned velocity and acceleration commands with respect to time for operating the vehicle within the longitudinal prediction horizon (e.g., a velocity plan for the next 12 seconds), and similarly, the lateral travel plan output by the motion planning module includes a sequence of planned steering angles and steering rates with respect to distance or position for steering the vehicle within the lateral prediction horizon while operating in accordance with the longitudinal travel plan (e.g., a steering plan for the next 50 meters). The longitudinal and lateral plan outputs are provided to the vehicle control system 80, which may utilize vehicle localization information and employs its own control schemes to generate control outputs that regulate the vehicle localization information to the longitudinal and lateral plans by varying velocity and steering commands provided to the actuators 30, thereby varying the speed and steering of the vehicle 10 to emulate or otherwise effectuate the longitudinal and lateral plans.

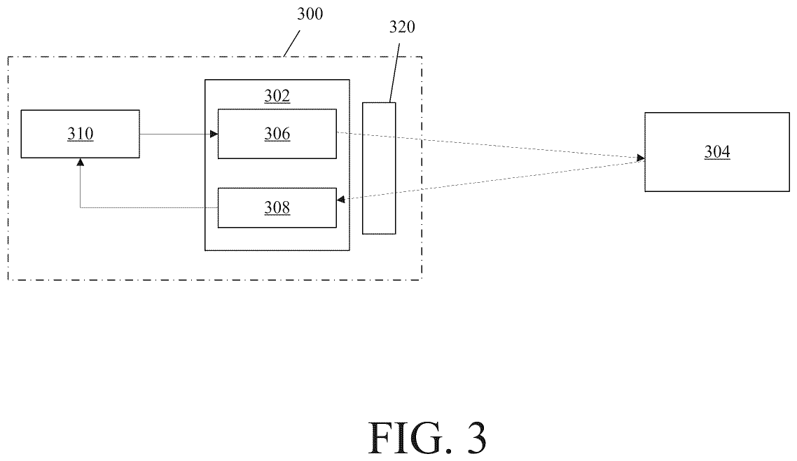

FIG. 3 depicts an exemplary sensor system 300 suitable for use with a vehicle, for example, as sensor system 28 onboard the vehicle 10 in vehicle system 100. The sensor system 300 includes a sensing device 302 that is disposed onboard a vehicle and oriented or otherwise configured to capture or otherwise obtain sensor measurement data indicative of a characteristic of an external object 304. For purposes of explanation, the subject matter is described herein in the context of the sensing device 302 being realized as a lidar (light detection and ranging) device that includes a light source 306, such as a laser, configurable to emit electromagnetic radiation and a detector 308, such as a photodetector, that is collocated with the light source 306 and configurable to detect at least a portion of the emitted electromagnetic radiation that is reflected back towards the sensing device 302 by the external object 304, resulting in sensor measurement data indicative of the distance between the sensing device 302 and the external object 304. For purposes of explanation, the sensing device 302 is alternatively referred to herein as a lidar or lidar sensing device. The illustrated lidar sensing device 302 is coupled to a control module 310, which generally represents any sort of processor, CPU, GPU, controller, microcontroller, or another suitable computing device and associated memory configurable to execute instructions for operating the light source 306 and receiving the sensor measurement data from the detector 308 to support the subject matter described herein.

Still referring to FIG. 3, in practice, the lidar sensing device 302 is packaged, oriented or otherwise disposed behind a structure 320 that resides between the lidar sensing device 302 and the external object 304 and is transparent to at least the range of wavelengths or portion of the spectrum of electromagnetic radiation emitted by the light source 306 and/or detected by the detector 308. In this regard, the structure 320 may be opaque or translucent to electromagnetic radiation within the visible light spectrum but transparent to electromagnetic radiation emitted by the light source 306 in the infrared spectrum, the microwave spectrum, the ultraviolet spectrum and/or the like. Thus, the structure 320 may alternatively be referred to herein as a transparent structure for purposes of explanation; however, it should be appreciated that the transparent structure is not necessarily required to be transparent to visible light or other portions of the electromagnetic spectrum. In practice, the transparent structure 320 may be realized as glass, a transparent polycarbonate, or any other suitable transparent material to achieve the desired optical, physical and/or aesthetic performance. For example, in some implementations, the transparent structure 320 may be realized as a windshield, window or another transparent structure that is part of the exterior surface of the vehicle. In other implementations, the transparent structure 320 may be realized as a protective lens, cover or other structure defining an aperture in at least a portion of the exterior surface of the sensing device 302, for example, to enable transmission of electromagnetic radiation to/from components (e.g., the light source 306 and the detector 308) residing within a housing of the sensing device 302. In this regard, in practice, the transparent structure 320 may encompass or span the entire field of view of the sensing device 302.

It should be appreciated that the particular configuration and arrangement of the lidar sensing device 302 and the transparent structure 320 are not germane to the subject matter described in the art, and numerous potential variations in implementations exists, and accordingly, the subject matter described herein is not intended to be limited to any particular type or configuration of the sensing device 302, the transparent structure 320 of the sensing system 300. For example, the subject matter described herein may be implemented in the context of a camera or any other suitable imaging device or sensing device capable of obtaining measurement data or other perception data pertaining to an external object 304, and the subject matter described herein is not limited to lidar or any particular type of sensing device 302.

As described in greater detail below, in exemplary implementations, the control module 310 executes or otherwise implements a crack detection service that is configurable to analyze sensor measurement data from the sensing device 302 to detect or otherwise identify when a crack or another anomalous condition exists with respect to the transparent structure 320 based on the sensor measurement data. The crack detection service obtains sets or frames of sensor measurement data corresponding to the field of view of the sensing device 302 and analyzes successive sets of sensor measurement data to detect or otherwise identify when a difference between successive sets of sensor measurement data is greater than a crack analysis threshold. For example, as described in greater detail below, in an exemplary implementation, when a difference between the average intensity value, average reflectivity (or calibrated intensity) value or other average measurement value for a metric of a respective frame of measurement data from the lidar sensing device 302 across successive frames of lidar measurement data is greater than a crack analysis threshold, the crack detection service identifies a potential anomalous condition with respect to the transparent structure 320. In this regard, when the average measurement value (e.g., average intensity, average reflectivity, etc.) across the field of view of the lidar sensing device 302 changes between successive frames at a subsequent point in time by more than the threshold amount, the crack detection service further analyzes the lidar measurement data to verify the presence of a crack or other anomalous condition associated with the transparent structure 320 within the field of view.

When the variation between successive frames of lidar measurement data exceeds the crack analysis threshold, the crack detection service subdivides the field of view into a plurality of discrete and distinct nonoverlapping zones (or sectors or regions) within the field of view, and then analyzes the respective subsets of a respective frame of lidar measurement data for a potential crack or other anomalous condition associated with its respective corresponding zone or sector within the overall field of view. For example, in one or more implementations, the crack detection service is configurable to divide the field of view of a lidar sensing device 302 into discrete nonoverlapping one degree by one degree sectors that define the respective zones of the field of view to be analyzed for crack detection. For each respective zone, the crack detection service compares the average intensity value, the average reflectivity value or other average value for a metric calculated based on the respective distinct subset of the lidar measurement data from the most recently obtained frame of lidar measurement data corresponding to the respective sector, zone or subset of the lidar field of view to the average value calculated based for the respective distinct subset of the lidar measurement data corresponding to the respective sector, zone or subset of the lidar field of view from the preceding frame of lidar measurement data. In this manner, the crack detection service detects or otherwise identifies a potential crack or other anomalous condition when the temporal difference in average measurement values across successive frames of lidar measurement data within a particular zone or sector of the lidar field of view is greater than a crack detection threshold. In this regard, the crack detection threshold value may be chosen to be large enough to avoid false positives due to rain, debris, or other transient external factors.

After detecting a potential crack or other anomalous condition with respect to an individual zone or sector of the lidar field of view, the crack detection service further validates or otherwise verifies the existence of the crack or other anomalous condition based on further analysis of the respective distinct subset of the lidar measurement data for that respective sector, zone or subset of the lidar field of view. For example, in some implementations, the crack detection service obtains a subsequent set or frame of lidar measurement data and then analyzes the respective distinct subset of the subsequent frame of lidar measurement data corresponding to the respective sector, zone or subset of the lidar field of view to verify or otherwise confirm that the difference relative to the preceding frame that resulted in the initial crack detection is less than a verification threshold. In this regard, once the crack detection service has detected or identified a potential anomalous condition with respect to a zone or sector of the field of view, the crack detection service analyzes one or more subsequent frames of lidar measurement data to ensure that the crack or other anomalous condition is persistent. Thus, when the respective subset of lidar measurement data within a particular zone or sector across successive frames initially varies by an amount greater than a crack detection threshold (e.g., based on a change in average measurement value spatially across the respective zone or sector temporally across successive frames) before subsequently staying constant or unchanged across successive frames (e.g., no significant change in average measurement value spatially across the respective zone or sector temporally across successive frames), the crack detection service verifies that a crack or other anomalous condition exists with respect to that particular zone or sector of the field of view. On the other hand, when the respective subset of lidar measurement data for the particular zone or sector continues to vary after initially violating the crack detection threshold, the crack detection service may fail to validate a crack and attribute the variations to rain, debris or other external factors.

In other implementations, the crack detection service validates the presence of the crack or other anomalous condition with respect to the transparent structure 320 based on the raw measurement data from the lidar sensing device 302. In this regard, the crack detection service may initially detect a potential crack or other anomalous condition based on the lidar point-cloud measurement data and then validate the presence of the crack or other anomalous condition detected based on the lidar point-cloud measurement data using the raw measurement data from the lidar 302. For example, the crack detection service validates the presence of the crack or other anomalous condition with respect to the transparent structure 320 based on a histogram of the respective distinct subset of the lidar measurement data for that respective sector, zone or subset of the lidar field of view. In this regard, the histograms for each of the individual lidar points within the respective sector, zone or subset of the lidar field of view are analyzed to detect or otherwise identify the distance associated with the first return within that distinct portion of the lidar field of view, based on the first peak in the spectrum of raw measurement data received and/or output by the detector 308. When a number of returns at or around a particular distance is greater than a threshold number, the mean, median or central point of those returns may be utilized to assign an estimated distance to the respective object responsible for reflecting the emitted electromagnetic radiation at that location on the spectrum. When the estimated distance associated with the first return for a sector or zone under analysis is less than a crack validation threshold distance corresponding to the distance between the light source 306 and the transparent structure 320, the lidar measurement data for the respective sector or zone is indicative of a crack or other anomalous condition in proximity to the light source 306 and/or sensing device 302, resulting in the crack detection service validating the crack with respect to the identified zone. In this regard, the crack validation threshold distance may be less than or equal to the distance between the light source 306 and the transparent structure 320.

After validating a crack or anomalous condition associated with a discrete zone or sector of the field of view, the crack detection service automatically initiates one or more remedial actions to mitigate the potentially anomalous sensor measurement data associated with that particular zone or sector. For example, in some implementations, the crack detection service may generate a flag or other signal for a guidance system (e.g., guidance system 78) or vehicle control system (e.g., vehicle control system 80) to automatically adjust, modify or disable an autonomous operating mode or an autonomous feature to deemphasize or otherwise reduce reliance on sensor measurement data from the affected lidar sensing device 302. In other implementations, the crack detection service may automatically discard or otherwise invalidate the respective subset of the sensor measurement data associated with the respective zone or sector within the field of view where a crack or other anomalous condition has been detected and validated to maintain availability or usability of the sensor measurement data associated with the remaining zones or sectors within the field of view to support an autonomous operating mode or an autonomous feature provided by a higher-level guidance system, vehicle control system, or the like. In some implementations, the crack detection service may implement a counter to track or otherwise maintain a count of the number of discrete zones or sectors within the field of view where a crack or other anomalous condition has been detected and validated and then automatically disable usage of the sensor measurement data once the total number of affected zones or sectors is greater than an allowable crack tolerance threshold. In this regard, an autonomous operating mode or an autonomous feature may be preserved or otherwise supported by the sensor measurement data while any validated crack or other anomalous condition is relatively smaller in size relative to the total field of view of the sensing device.

In one or more implementations, the crack detection service automatically initiates generation of a user notification that alerts the driver or other operator of the vehicle of a potential issue associated with the sensing device 302 (e.g., by illuminating one or more dashboard indicators), so that a user may manually inspect or verify the presence of a crack or anomalous condition (e.g., verifying the sensing device 302 is not covered or obstructed by another object), schedule service, or manually initiate another remedial action to restore normal operation of the sensing device 302. In this regard, in some implementations, the crack detection service may generate or otherwise provide a graphical user interface (GUI) display including one or more GUI elements manipulable by a driver or other user to allow the driver or user to manually control availability of the measurement data from the sensing device 302 and/or other autonomous operating modes or features based thereon. In this regard, it should be appreciated that numerous different potential remedial actions exist, and the subject matter described herein is not intended to be limited to any particular type, number or combination of remedial actions that may be undertaken to mitigate a crack or other anomalous condition that has been detected and validated with respect to a transparent structure 320 associated with a sensing device 302.

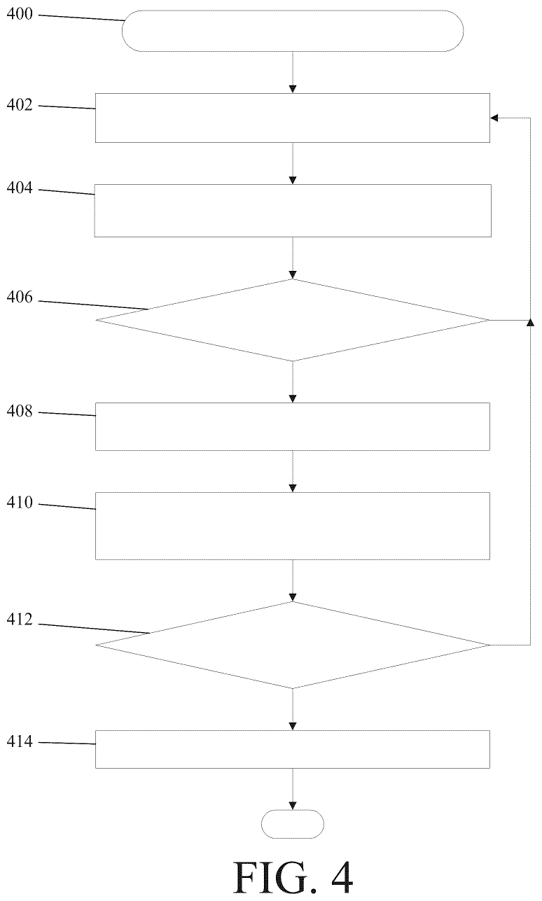

FIG. 4 depicts an exemplary crack detection process 400 suitable for implementation by a crack detection service or other service associated with a sensing system of a vehicle capable of autonomously controlling operation of a propulsion system or other actuators of a vehicle. For illustrative purposes, the following description may refer to elements mentioned above in connection with FIGS. 1-3. While portions of the crack detection process 400 may be performed by different elements of a vehicle system, for purposes of explanation, the subject matter may be primarily described herein in the context of the crack detection process 400 being primarily performed by a crack detection service or another similar feature or service implemented at a controller 34 or other control module associated with a control system of a vehicle 10 that is communicatively coupled to one or more sensing devices 40 of a sensor system 28.

Referring now to FIG. 4 with continued reference to FIGS. 1-3, in exemplary implementations, the crack detection process 400 is performed during operation of a vehicle 10 to continually monitor a state of any transparent structures disposed within the field of view of one or more sensing devices 40 onboard the vehicle 10. For purposes of explanation, but without limitation, the crack detection process 400 is described in the context of monitoring a transparent structure 320 disposed within the line-of-sight or field of view of a lidar sensing device 302. That said, the crack detection process 400 may be implemented in an equivalent manner in the context of any suitable transparent structure or surface disposed within the line-of-sight or field of view of any type of sensing device, including, but not limited to cameras, imaging devices, infrared devices, ultrasonic devices, and/or the like. Additionally, although the crack detection process 400 is described herein in the context of a crack, it should be appreciated that the subject matter described herein is not limited to a crack and may be implemented in the context of any sort of persistent imperfection, defect, environmental variable or other anomalous condition capable of influencing measurement data obtained from a sensing device that may arise during operation of a vehicle 10.

At 402, the crack detection process 400 receives or otherwise obtains a set of measurement data captured by a sensing device for a field of view of a sensing device and calculates or otherwise determines an average value for a metric across the field of view of the sensing device based on the set of measurement data at 404. For example, a crack detection service at the control module 310 obtains a frame of lidar measurement data captured by the photodetector 308 of the lidar sensing device 302 in response to periodic operation of the light source(s) 306. As will be appreciated in the art, a frame of lidar measurement data generally includes a plurality of discrete data points corresponding to respective locations or orientations within the field of view of the lidar sensing device 302 having respective reflectivity values indicative of a relative distance to one or more external objects within the line-of-sight of the lidar sensing device 302 at the respective location or orientation within the field of view that reflect electromagnetic radiation emitted by the light source(s) 306 back to the photodetector 308 at the respective location or orientation. In practice, each data point or location may include a plurality of different returns indicative of the relative distance to the transparent structure 320 and any other external objects 304 (if present) that are within the line-of-sight at the respective location or orientation relative to the lidar sensing device 302. The respective reflectivity values of the respective data points are averaged or otherwise combined to obtain an average measurement value (e.g., average intensity, average reflectivity, etc.) across the field of view of the lidar sensing device 302.

At 406, the crack detection process 400 verifies or otherwise confirms that the average value of the metric across the field of view of the sensing device is less than a crack analysis threshold indicative of a potential crack or other anomalous condition. In this regard, in the absence of a crack or other anomalous condition, the average measurement value across the field of view of the lidar sensing device 302 would be expected to vary temporally from frame to frame by less than the crack analysis threshold, such that a frame to frame deviation in the average intensity (or reflectivity) value that is greater than the crack analysis threshold is sufficiently likely to be attributable to a crack or other anomalous condition with respect to the transparent structure 320 rather than the external environment. Thus, when the average intensity (or reflectivity) value across a frame of sensor measurement data from the lidar sensing device 302 is substantially equal to the average intensity (or reflectivity) value for the preceding frame of sensor measurement data or otherwise within the threshold of the average intensity (or reflectivity) value across the preceding frame from the lidar sensing device 302, the crack detection process 400 determines that a crack is unlikely to be present. In exemplary implementations, the crack detection process 400 repeats the loop defined by 402, 404 and 406 throughout operation of the vehicle 10 to continually monitor each frame of sensor measurement data from the lidar sensing device 302 with respect to the preceding frame of sensor measurement data at the sampling rate or frequency of the lidar sensing device 302 to dynamically detect the presence of a crack or other anomalous condition substantially in real-time.

When the difference in the average value of the metric for the field of view of the sensing device across successive sets of measurement data varies by more than the crack analysis threshold, the crack detection process 400 continues by partitioning or otherwise dividing the set of measurement data into discrete nonoverlapping subsets corresponding to discrete nonoverlapping zones or regions of the field of view at 408 and identifying or otherwise determining which of the zones or regions exhibit a temporal difference in the average value of the metric over successive frames that is greater than a zone analysis threshold at 410. In this regard, in the absence of a crack or other anomalous condition, the average measurement value within a discrete zone or region within the field of view of the lidar sensing device 302 would be expected to vary temporally from frame to frame by less than the zone analysis threshold, such that a frame to frame deviation in the average measurement value within a particular zone or region that is greater than the zone analysis threshold is sufficiently likely to be attributable to a crack or other anomalous condition with respect to the transparent structure 320 within that particular zone or region of the field of view. Thus, when the average of a respective subset of reflectivity values across successive frames of sensor measurement data from the lidar sensing device 302 for a particular zone or sector of the lidar field of view are substantially equal to or otherwise within the zone analysis threshold, the crack detection process 400 determines that a crack is unlikely to be present within those particular zones or sectors of the field of view and excludes those zones or sectors from further analysis.

At 412, for a particular zone or sector within the field of view exhibiting a temporal difference across successive sets (or samples or frames) of sensor measurement data, the crack detection process 400 continues by validating or otherwise verifying the presence of a crack or other anomalous condition with respect to that particular zone or sector within the field of view. When a zone or sector within the field of view is identified as potentially exhibiting a crack or other anomalous condition, the crack detection process 400 validates, verifies or otherwise confirms the presence of the crack or other anomalous condition based on further analysis of the respective subset of sensor measurement data for that zone or sector within the field of view prior to initiating one or more remedial actions at 414. In this regard, the number, type and/or manner of remedial actions initiated by the crack detection process 400 may vary depending on the particular zone(s) or sector(s) within the field of view where the crack or other anomalous condition has been detected and validated, and/or the number, type and/or manner of remedial actions initiated by the crack detection process 400 may vary depending on the total number of zone(s) or sector(s) within the field of view where a crack or other anomalous condition has been detected and validated.

In one or more implementations, the crack detection process 400 validates the presence of a crack or another anomalous condition with respect to a particular zone by comparing the respective subset of sensor measurement data for that zone that resulted in the initial detection of the crack with a corresponding subset of subsequently obtained sensor measurement data for that zone to verify persistence of the crack across successive samples. In this regard, after initially detecting a potential crack with respect to a particular zone within the lidar field of view at a first sampling time (t₁) when the difference between the averages of the respective subsets of reflectivity values across successive frames of sensor measurement data from the lidar sensing device 302 (e.g., relative to the measurement data from a preceding sampling time (t₀)) for that zone is greater than the zone analysis threshold, the crack detection process 400 validates the presence of a crack at that particular zone when the average of a respective subset of reflectivity values obtained from the lidar sensing device 302 for that zone from a subsequent frame of lidar sensor measurement data at a subsequent sampling time (t₂) is equal to or otherwise within a crack validation threshold value of the preceding average measurement value for that zone at the preceding sampling time (t₁).

For example, after detecting or identifying a zone exhibiting a potential crack at 410 at time t₁ (based on a difference relative to lidar measurement data from time t₀), the crack detection process 400 obtains the next subsequent frame of lidar measurement data from the lidar sensing device 302 at time t₂ and extracts or otherwise identifies the respective subset of lidar measurement data at time at time t₂ collocated with or otherwise corresponding to the zone or sector where the potential crack was detected. Thereafter, the crack detection process 400 calculates or otherwise determines an average measurement value for that respective zone at time t₂ and validates the detection of the crack when the average measurement value for that respective zone at time t₂ is within a crack validation threshold of the average measurement value for that respective zone at time t₁ (e.g., when a difference in zone average measurement values for a particular zone between sampling times t₁ and t₂ is less than the crack validation threshold). Thus, a crack or other anomalous condition occurring in a particular zone between sampling time t₀ and time t₁ is validated and detected when the lidar sensor measurement data for that zone is substantially constant between sampling time t₁ and time t₂, thereby indicating that the condition is persistent over time. Alternatively, when the lidar sensor measurement data for that zone varies between sampling time t₁ and time t₂, the potential crack or other anomalous condition is discarded or disregarded as being transient or spurious in nature.

In other implementations, crack detection process 400 validates the presence of a crack or another anomalous condition with respect to a particular zone based on a histogram of the respective subset of the lidar measurement data for that respective zone of the lidar field of view. For example, after initially detecting a potential crack with respect to a particular zone within the lidar field of view at a first sampling time (t₁), the histograms for the individual lidar points within that respective zone of the lidar field of view are analyzed to detect or otherwise identify the estimated distance associated with the first returns within that distinct subset of the lidar field of view. When the estimated distance of the first returns within a zone identified at 410 as potentially exhibiting a crack or other anomalous condition is less than a validation threshold distance, the crack detection process 400 determines the first returns are attributable to a crack or other anomalous condition with respect to the transparent structure 320 aligned with that line-of-sight through that particular zone rather than some other external object 304 that is disposed further from the lidar sensing device 302. In this manner, the crack detection process 400 validates and detects the presence of the crack or other anomalous condition associated with a particular zone in a manner that is independent of the average value(s) for the metric utilized to initially trigger further analysis of the zone at 406 and 410 of the crack detection process 400.

After validating and detecting a crack associated with one or more zones of the sensor field of view, the crack detection process 400 automatically initiates one or more remedial actions to mitigate the potential impact of the crack at 414. For example, in some implementations, the crack detection process 400 may automatically generate a GUI display or other user notification for a driver or other user associated with the vehicle 10 to inform the driver or other user of the crack to enable manual inspection of the transparent structure 320 and/or manual control over the manner in which the ADS 70 or other vehicle control system responds to the crack. In exemplary implementations, the crack detection service implements or otherwise maintains a counter or other log for tracking the total number of cracks detected by the crack detection process 400 and the respective zones or sectors of the sensor field of view associated with the detected cracks to assist or otherwise facilitate subsequent maintenance and/or inspection of the transparent structure 320. Additionally, in one or more exemplary implementations, the crack detection service automatically generates a flag, command or other signal to the ADS 70 or other vehicle control system including information characterizing the number impacted zones and/or physical orientation of the impacted zones where a crack is detected to enable the ADS 70 or other vehicle control system to automatically implement one or more remedial actions to mitigate the crack, for example, by ceasing utilization of the affected sensing device 302 in connection with certain autonomous operating modes or other autonomous driving features supported by the ADS 70 that might otherwise rely on sensor measurement data for the particular zone(s) of the sensing device. In this regard, it should be appreciated that there are numerous different potential remedial actions or combinations thereof that could be undertaken, which may vary depending on the size, location and/or severity of the crack or other anomalous condition, and the subject matter described herein is not limited to any particular type, number or combination of remedial actions to be initiated in response to validating and detecting a crack in a transparent structure 320 associated with a sensing device 302.

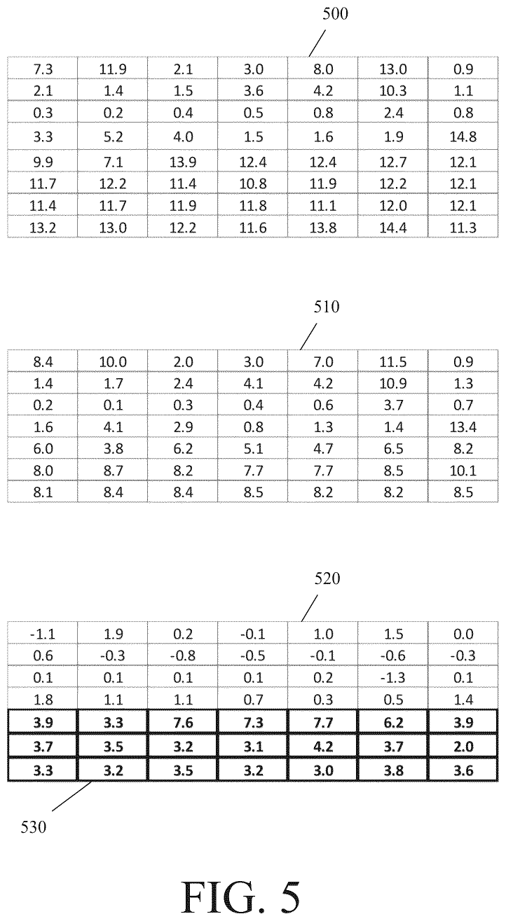

FIG. 5 depicts an exemplary relationship between average measurement values for different sectors or zones of a first frame 500 of lidar measurement data at an initial sampling time (e.g., t₀), average measurement values for those sectors or zones of a second frame 510 of lidar measurement data at the next succeeding sampling time (e.g., t₁), and a relative difference 520 in average measurement values for the respective sectors or zones across successive samples (e.g., t₁−t₀). FIG. 5 corresponds to a scenario where the crack detection process 400 detects the presence of a crack with respect to the bottom or lower subset 530 of sectors or zones identified as having a relative difference value greater than a crack detection threshold value of 2.0 at 410 of the crack detection process 400 after determining the difference between the average measurement value across the entirety of the respective frames 500, 510 deviates by more than a crack analysis threshold at 406. In this regard, at 412, when the average measurement value for an individual sector or zone within the subset 530 identified at 410 at a subsequent sampling time (e.g., t₂) is substantially equal to its respective average measurement value from the preceding frame 510, the crack detection process 400 validates a crack with respect to that particular sector or zone within the subset 530 and initiates corresponding remedial action based on the validated crack with respect to that particular sector or zone at 414 as described above.

For sake of brevity, conventional techniques related to vehicle controls, driver assistance features, autonomous vehicles, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an implementation of the subject matter.

As used herein, the word “exemplary” means “serving as an example, instance, or illustration.” Thus, any implementation described herein as “exemplary” is not necessarily to be construed as preferred or advantageous over other implementations. All of the implementations described herein are exemplary implementations provided to enable persons skilled in the art to make or use the invention and not to limit the scope of the invention which is defined by the claims.

Those of skill in the art will appreciate that the various illustrative logical blocks, modules, circuits, and algorithm steps described in connection with the implementations disclosed herein may be implemented as electronic hardware, computer software, or combinations of both. Some of the implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is logically coherent.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A method of operating a vehicle, the method comprising:
obtaining, by a controller associated with the vehicle from a lidar associated with the vehicle, a first set of measurement data associated with a field of view of the lidar;
obtaining, by the controller, a second set of measurement data associated with the field of view of the lidar at a subsequent point in time;
identifying, by the controller, when a difference between a first average of the first set of measurement data and a second average of the second set of measurement data is greater than a zone analysis threshold; and
when the difference is greater than the zone analysis threshold:
identifying, by the controller, an anomalous condition associated with a distinct subset of the field of view when a second difference between respective subsets of the first set of measurement data and the second set of measurement data corresponding to the distinct subset of the field of view is greater than an anomaly detection threshold;
validating, by the controller, the anomalous condition associated with the distinct subset of the field of view based on the respective subset of the second set of measurement data corresponding to the distinct subset of the field of view; and
automatically initiating, by the controller, one or more remedial actions in response to validating the anomalous condition associated with the distinct subset of the field of view.

2. The method of claim 1, wherein:
the first set of measurement data comprises a first frame of lidar measurement data at a first sampling time;
the second set of measurement data comprises a second frame of lidar measurement data at a second sampling time subsequent to the first sampling time;
identifying the difference is greater than the zone analysis threshold comprises identifying the difference between a first average value for the first frame of lidar measurement data and a second average value for the second frame of lidar measurement data is greater than the zone analysis threshold; and
identifying the anomalous condition comprises identifying a crack associated with a distinct zone within the field of view when the second difference between a third average value for a first subset of the first frame of lidar measurement data corresponding to the distinct zone and fourth average value for a second subset of the second frame of lidar measurement data corresponding to the distinct zone is greater than a crack detection threshold.

3. The method of claim 2, wherein:
validating the anomalous condition comprises validating detection of the crack when a third difference between the fourth average value for the second subset of the second frame of lidar measurement data and a fifth average value for a third subset of a third frame of lidar measurement data at a third sampling time corresponding to the distinct zone is less than a crack validation threshold; and
the third sampling time is subsequent to the second sampling time.

4. The method of claim 2, wherein the crack is disposed within a transparent structure in a line-of-sight of the lidar aligned with the distinct zone within the field of view.

5. The method of claim 1, further comprising obtaining, by the controller, a third set of measurement data associated with the field of view of the lidar at a third point in time after identifying the anomalous condition, wherein validating the anomalous condition comprises validating persistence of the anomalous condition when a third difference between respective subsets of the second set of measurement data and the third set of measurement data corresponding to the distinct subset of the field of view is less than a validation threshold.

6. The method of claim 1, wherein validating the anomalous condition comprises validating detection of a crack in a transparent structure in a line-of-sight of the lidar aligned with the distinct subset of the field of view when an estimated distance associated with first returns associated with the respective subset of the second set of measurement data corresponding to the distinct subset of the field of view is less than a crack validation threshold.

7. The method of claim 6, wherein the crack validation threshold is less than or equal to a distance between a light source of the lidar and the transparent structure.

8. The method of claim 1, wherein:
the first set of measurement data comprises a first frame of lidar measurement data from the lidar at a first sampling time;
the second set of measurement data comprises a second frame of lidar measurement data from the lidar at a second sampling time subsequent to the first sampling time;
identifying the difference is greater than the zone analysis threshold comprises identifying the difference between a first average measurement value for the first frame of lidar measurement data and a second average measurement value for the second frame of lidar measurement data is greater than the zone analysis threshold; and
identifying the anomalous condition comprises identifying a crack associated with a transparent structure in a line-of-sight of the lidar within a distinct zone within the field of view when the second difference between a third average measurement value for a first subset of the first frame of lidar measurement data corresponding to the distinct zone and fourth average measurement value for a second subset of the second frame of lidar measurement data corresponding to the distinct zone is greater than a crack detection threshold.

9. The method of claim 8, wherein:
validating the anomalous condition comprises validating detection of the crack when a third difference between the fourth average measurement value for the second subset of the second frame of lidar measurement data and a fifth average measurement value for a third subset of a third frame of lidar measurement data from the lidar at a third sampling time corresponding to the distinct zone is less than a crack validation threshold; and
the third sampling time is subsequent to the second sampling time.

10. A non-transitory computer-readable medium comprising executable instructions that, when executed by a processor, cause the processor to provide a crack detection service configurable to:
obtain, from a lidar associated with a vehicle, a first set of sensor data associated with a field of view of the lidar;
obtain, from the lidar, a second set of sensor data associated with the field of view of the lidar at a subsequent point in time;
identify when a difference between a first average of the first set of sensor data and a second average of the second set of sensor data is greater than a zone analysis threshold; and
when the difference is greater than the zone analysis threshold:
identify a crack associated with a distinct subset of the field of view when a second difference between respective subsets of the first set of sensor data and the second set of sensor data corresponding to the distinct subset of the field of view is greater than a crack detection threshold;
validate detection of the crack associated with the distinct subset of the field of view based on the respective subset of the second set of sensor data corresponding to the distinct subset of the field of view; and
automatically initiate one or more remedial actions in response to validating detection of the crack associated with the distinct subset of the field of view.

11. The non-transitory computer-readable medium of claim 10, wherein the first set of sensor data comprises a first frame of sensor measurement data at a first sampling time, the second set of sensor data comprises a second frame of sensor measurement data at a second sampling time subsequent to the first sampling time, and the crack detection service is configurable to:
identify the difference between a first average value for the first frame of sensor measurement data and a second average value for the second frame of sensor measurement data is greater than the zone analysis threshold; and
identify the crack associated with a distinct zone within the field of view when the second difference between a third average value for a first subset of the first frame of sensor measurement data corresponding to the distinct zone and fourth average value for a second subset of the second frame of sensor measurement data corresponding to the distinct zone is greater than the crack detection threshold.

12. The non-transitory computer-readable medium of claim 11, wherein the crack detection service is configurable to validate the detection of the crack when a third difference between the fourth average value for the second subset of the second frame of sensor measurement data and a fifth average value for a third subset of a third frame of sensor measurement data at a third sampling time corresponding to the distinct zone is less than a crack validation threshold, wherein the third sampling time is subsequent to the second sampling time.

13. The non-transitory computer-readable medium of claim 10, wherein the crack is disposed within a transparent structure in a line-of-sight of the lidar aligned with a distinct zone within the field of view.

14. The non-transitory computer-readable medium of claim 10, wherein the crack detection service is configurable to:
obtain a third set of sensor data associated with the field of view of the lidar at a third point in time after identifying the crack; and
validate the detection of the crack when a third difference between respective subsets of the second set of sensor data and the third set of sensor data corresponding to the distinct subset of the field of view is less than a crack validation threshold.

15. The non-transitory computer-readable medium of claim 10, wherein the crack detection service is configurable to validate the detection of the crack in a transparent structure in a line-of-sight of the lidar aligned with the distinct subset of the field of view when an estimated distance of first returns associated with the respective subset of the second set of sensor data corresponding to the distinct subset of the field of view is less than a crack validation threshold.

16. The non-transitory computer-readable medium of claim 15, wherein the crack validation threshold is less than or equal to a distance between a light source of the lidar and the transparent structure.

17. The non-transitory computer-readable medium of claim 10, wherein:
the first set of sensor data comprises a first frame of lidar sensor measurement data from the lidar at a first sampling time;
the second set of sensor data comprises a second frame of lidar sensor measurement data from the lidar at a second sampling time subsequent to the first sampling time; and
the crack detection service is configurable to:
identify the difference between a first average measurement value for the first frame of lidar sensor measurement data and a second average measurement value for the second frame of lidar sensor measurement data is greater than the zone analysis threshold; and
identify the crack associated with a transparent structure in a line-of-sight of the lidar within a distinct zone within the field of view when the second difference between a third average measurement value for a first subset of the first frame of lidar sensor measurement data corresponding to the distinct zone and fourth average measurement value for a second subset of the second frame of lidar sensor measurement data corresponding to the distinct zone is greater than the crack detection threshold.

18. The non-transitory computer-readable medium of claim 17, wherein the crack detection service is configurable to validate the detection of the crack when a third difference between the fourth average measurement value for the second subset of the second frame of lidar sensor measurement data and a fifth average measurement value for a third subset of a third frame of lidar sensor measurement data from the lidar at a third sampling time corresponding to the distinct zone is less than a crack validation threshold, wherein the third sampling time is subsequent to the second sampling time.

19. A vehicle comprising:
a lidar sensing device;
a transparent structure disposed within a field of view of the lidar sensing device; and
a control module coupled to the lidar sensing device, wherein the control module is configurable to:
obtain, from the lidar sensing device, a first set of sensor data associated with the field of view of the lidar sensing device;
obtain, from the lidar sensing device, a second set of sensor data associated with the field of view of the lidar sensing device at a subsequent point in time;
identify when a difference between a first average of the first set of sensor data and a second average of the second set of sensor data is greater than a zone analysis threshold; and
when the difference is greater than the zone analysis threshold:
identify a crack associated with the transparent structure within a distinct subset of the field of view when a second difference between respective subsets of the first set of sensor data and the second set of sensor data corresponding to the distinct subset of the field of view is greater than a crack detection threshold;
validate detection of the crack associated with the distinct subset of the field of view based on the respective subset of the second set of sensor data corresponding to the distinct subset of the field of view; and
automatically initiate one or more remedial actions in response to validating detection of the crack associated with the distinct subset of the field of view.

20. The vehicle of claim 19, wherein:
the first set of sensor data comprises a first frame of lidar sensor measurement data from the lidar sensing device at a first sampling time;
the second set of sensor data comprises a second frame of lidar sensor measurement data from the lidar sensing device at a second sampling time subsequent to the first sampling time; and
the control module is configurable to:
identify the difference between a first average measurement value for the first frame of lidar sensor measurement data and a second average measurement value for the second frame of lidar sensor measurement data is greater than the zone analysis threshold; and
identify the crack associated with the transparent structure within a distinct zone within the field of view when the second difference between a third average measurement value for a first subset of the first frame of lidar sensor measurement data corresponding to the distinct zone and fourth average measurement value for a second subset of the second frame of lidar sensor measurement data corresponding to the distinct zone is greater than the crack detection threshold.
